(19) United States
(12) Patent Application Publication
(10) Pub. No.: US 2002/0136588 A1
(43) Pub. Date: Sep. 26, 2002

(54) Cosmetic tool for releasably holding cosmetic products

(76) Inventor: Tania W. Hanna, Vienna, VA (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 09/816,416

(22) Filed: Mar. 26, 2001

(51) Int. Cl. B43K 27/02; A47L 13/12

(52) U.S. Cl. 401/19; 401/16

(57) ABSTRACT

A cosmetic tool for holding multiple cosmetic products. The cosmetic tool can releasably hold at least one of the cosmetic products so that it can be replaced. The cosmetic tool includes a main body having two ends that hold the cosmetic products substantially parallel to a central axis of the tool, and it can also include caps for placement over the cosmetic products. The caps can have a reflective outer surface for use as a mirror. The ends can be configured to hold cosmetic products having variable dimensions by using a chuck mechanism or a compressible material. With cosmetic products held in place and the caps installed, the cosmetic tool provides for a convenient and easy way to carry and use a wide variety of cosmetic products such as lipstick, lip liner, eye liner, eye shadow, or others products.

### FIELD OF THE INVENTION

The present invention relates to a cosmetic tool for holding multiple cosmetic products, at least one of which is releasably held.

### BACKGROUND OF THE INVENTION

Individuals often use cosmetic products in order to enhance their appearance. These cosmetic products include, for example, lipstick and lip liner. The application of lipstick generally involves first applying lip liner to outline the lips and then applying lipstick over the lips. When a person applies lipstick to oneself, the application also requires a mirror to ensure proper application of the lip liner and lipstick.

The cosmetic products are usually carried in a container, such as purse, to have them available at various times throughout the day to apply or re-apply the products. Therefore, use of lipstick requires a person to carry at least three articles, lip liner, lipstick, and a mirror. These three separate articles can be cumbersome to carry in a purse and, when contained in a large purse or bag, can be difficult to locate if mixed in with many other items. Carrying additional cosmetic products such as eye liner and eye shadow only compounds the problem.

Accordingly, a need exists for a more convenient way to carry and hold multiple cosmetic products.

### SUMMARY OF THE INVENTION

A cosmetic tool consistent with the present invention includes a main body having first and second ends. The first end has a first holder for holding a first cosmetic product, and the second end has a second holder for holding a second cosmetic product. At least one of the first or second holders, and possibly both, provides for releasably holding one of the cosmetic products so that it can be replaced.

### BRIEF DESCRIPTION OF THE DRAWINGS

The accompanying drawings are incorporated in and constitute a part of this specification and, together with the description, explain the advantages and principles of the invention. In the drawings,

FIG. 1 is a perspective view of an embodiment of a cosmetic tool for releasably holding cosmetic products;

FIG. 2 is a side view of the cosmetic tool shown in FIG. 1;

FIG. 3 is a first end view of the cosmetic tool shown in FIG. 1;

FIG. 4 is a second end view of the cosmetic tool shown in FIG. 1;

FIG. 5 is a perspective view of an embodiment of a cosmetic tool for releasably holding cosmetic products and optionally including caps;

FIG. 6 is a side view of the cosmetic tool shown in FIG. 5;

FIG. 7 is a side view of a cap shown with the cosmetic tool in FIG. 5;

FIG. 8 is a first end view of the cosmetic tool shown in FIG. 5;

FIG. 9 is a second end view of the cosmetic tool shown in FIG. 5;

FIG. 10 is a side sectional view of a portion of the cosmetic tool shown in FIG. 5 illustrating an optional holder for releasably containing a cosmetic product;

FIG. 11 is a side sectional view of the cosmetic tool shown in FIG. 5 illustrating a friction fit for the caps;

FIG. 12 is a side sectional view of the cosmetic tool shown in FIG. 5 illustrating a snap fit for the caps;

FIG. 13 is a side sectional view of the cosmetic tool shown in FIG. 5 illustrating a threaded fit for the caps;

FIG. 14 is a perspective view of the cosmetic tool shown in FIG. 5 with the caps installed;

FIG. 15 is a perspective view of an embodiment of a cosmetic tool for releasably holding cosmetic products and including a chuck mechanism for holding variable size cosmetic products;

FIG. 16 is an end view of the cosmetic tool shown in FIG. 15;

FIG. 17 is a perspective view of an embodiment of a cosmetic tool for releasably holding cosmetic products and including a compressible material for holding variable size cosmetic products;

FIG. 18 is a side sectional view of the cosmetic tool shown in FIG. 18; and

FIG. 19 is a side sectional view of the cosmetic tool shown in FIG. 18 with cosmetic products installed.

### DETAILED DESCRIPTION

### Cosmetic Tool

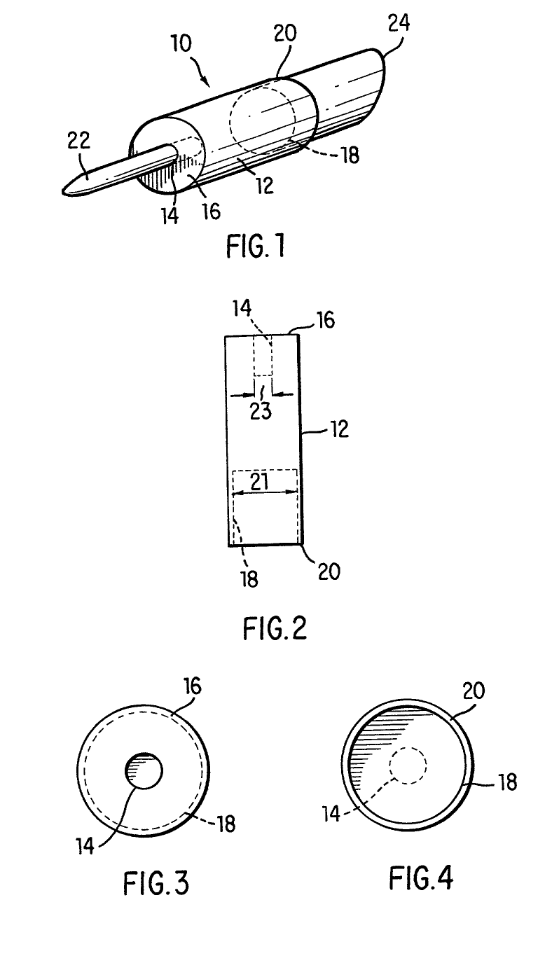

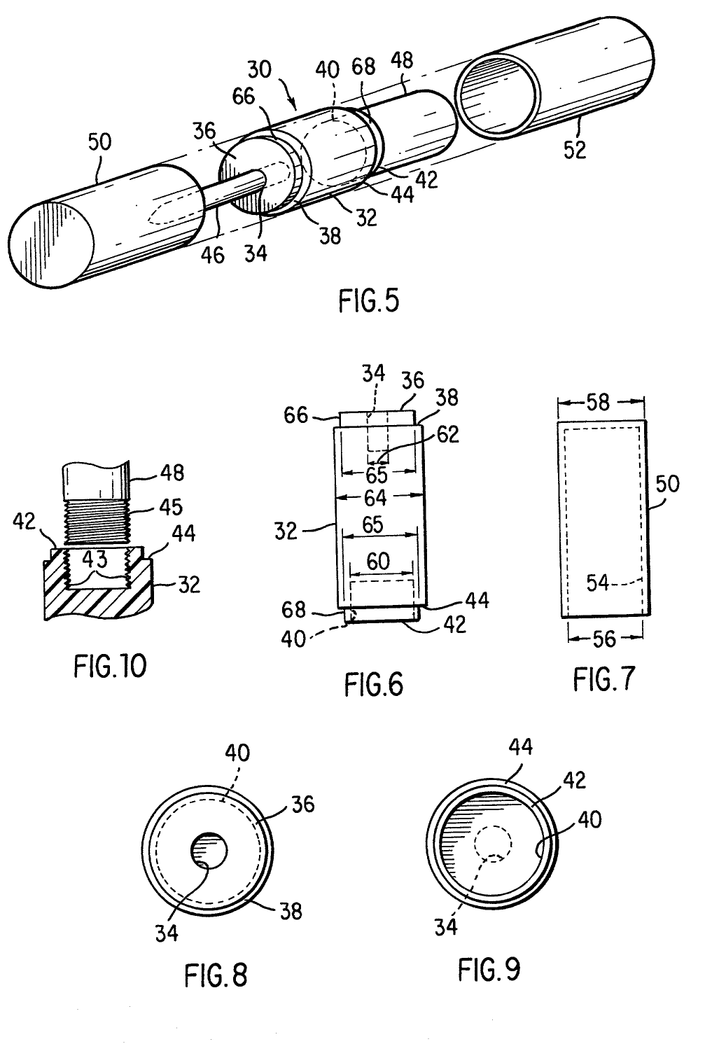

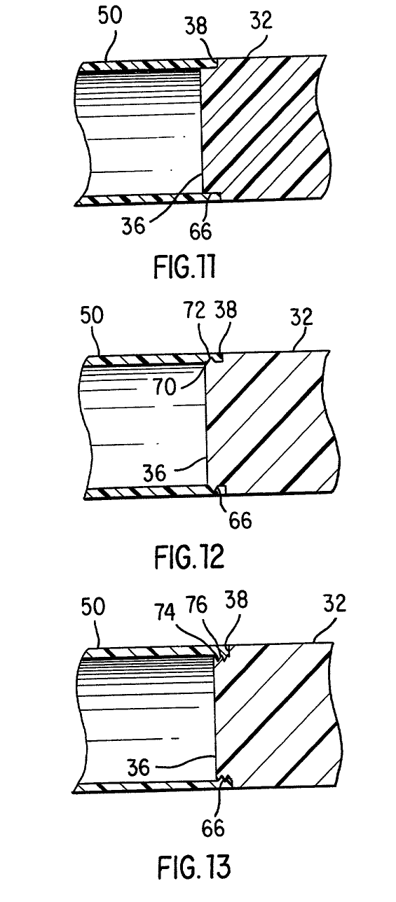

A cosmetic tool consistent with the present invention can provide for a convenient way to hold multiple cosmetic products for keeping them together and for use in applying them. FIG. 1 is a perspective view of an embodiment of a cosmetic tool 10 for releasably holding cosmetic products 22 and 24. FIG. 2 is a side view of cosmetic tool 10, and FIGS. 3 and 4 are views of opposite ends of cosmetic tool 10. Examples of cosmetic products include, but are not limited to, the following: lipstick; lip brush; lip liner; eye liner; and eye shadow. The term “cosmetic product” includes any type of cosmetic in any type of container.

As shown in FIGS. 1-4, cosmetic tool 10 includes a main body 12, which has two ends 16 and 20. Each end 16 and 20 has a holder for holding a cosmetic product, and the holder can be implemented in many ways, examples of which are described below. The term “holder” includes any structure for holding a cosmetic product. End 16 has an aperture 14 for releasably holding cosmetic product 22, and end 20 has an aperture 18 for releasably holding cosmetic product 24. As shown, cosmetic products 22 and 24 are held in place substantially parallel to a central longitudinal axis of main body 12, although they could be held at an angle to main body 12.

FIG. 2 is a side view of the cosmetic tool shown in FIG. 1 illustrating how cosmetic products 22 and 24 can be releasably held in this exemplary embodiment. Aperture 14 in end 16 has a diameter 23 slightly less than a cross-sectional diameter of cosmetic product 22, providing for a friction fit of the cosmetic product, and aperture 18 in end 20 has a diameter 21 slightly less than a cross-sectional diameter of cosmetic product 24, providing for a friction fit of the cosmetic products into the respective ends of the cosmetic tool. Apertures 14 and 18 also have a sufficient depth such that friction between the apertures and the ends of the cosmetic products holds them securely in place and also permits them to be released from the ends and replaced with, for example, new cosmetic products.

### Cosmetic Tool with a Friction Fit, Threaded Fit, and Optional Caps

FIG. 5 is a perspective view of an embodiment of a cosmetic tool 30 for releasably holding cosmetic products 46 and 48, and optionally including caps 50 and 52. FIG. 6 is a side view of cosmetic tool 30, and FIG. 7 is a side view of cap 50. FIGS. 8 and 9 are opposite end views of cosmetic tool 30. Caps 50 and 52 are not necessarily required since the cosmetic products themselves typically already have caps. However, they can provide certain advantages or may be desired for any reason. Caps can be used, for example, to help protect the cosmetic products so that they are not jarred loose from the main body such as when stored within a purse and so that any individual caps on the cosmetic products are not necessarily needed. Also, the caps can have an exterior reflective surface to function as a mirror and assist a user in applying cosmetic products held within cosmetic tool 30 or for other purposes.

As shown in FIGS. 5-9, cosmetic tool 30 includes a main body 32, which has two ends 36 and 42. Each end includes a holder as explained below. End 36 has an aperture 34 for releasably holding cosmetic product 46, and end 42 has an aperture 40 for releasably holding cosmetic product 48. As shown, cosmetic products 46 and 48 are held in place substantially parallel to a central longitudinal axis of main body 32, although they could be held at an angle to main body 32.

Cosmetic tool 30 in this exemplary embodiment also includes an alternative end structure. In particular, end 36 includes an edge 38 and a raised portion 66, and end 42 includes an edge 44 and a raised portion 68. The raised portions 66 and 68 provide for releasably securing caps 50 and 52 to main body 32. As shown in FIGS. 7 and 8, cap 50 has an interior portion 54 having a diameter 56 slightly less then diameter 65 of end 36, providing for a friction fit between interior portion 54 and raised portion 66. Cap 52 can have a similar construction so that it can be releasably held on end 42 through a friction fit with raised portion 68. Also, as shown in FIGS. 7 and 8 for this example, cap 50 has an outside diameter 58 substantially equal to diameter 64 of main body 32, and cap 52 likewise can have a similar construction and outside diameter dimension.

FIG. 6 also illustrates how cosmetic products 46 and 48 can be releasably held in this exemplary embodiment. Aperture 34 in end 36 has a diameter 62 slightly less than a cross-sectional diameter of cosmetic product 46, providing for a friction fit of the cosmetic product, and aperture 40 in end 42 has a diameter 60 slightly less than a cross-sectional diameter of cosmetic product 48, providing for a friction fit of the cosmetic products into the respective ends of the cosmetic tool. Apertures 34 and 40 also have a sufficient depth such that friction between the apertures and ends of the cosmetic products holds them securely in place and also permits them to be released from the ends and replaced with, for example, new cosmetic products.

FIG. 10 is a side view of a portion of cosmetic tool 30 illustrating an optional holder for releasably containing a cosmetic product. End 42 can alternatively include threading 43, and cosmetic product 48 can be configured to include matching threading 45 on its exterior. Therefore, cosmetic product 48 can be screwed onto end 42 and held securely in place. For replacement, cosmetic product 48 can be unscrewed and a new one also having threading 45 can be installed.

FIGS. 11-13 are side sectional views of an end of main body 32 illustrating the friction fit of cap 50 for installation and alternative ways to releasably install cap 50 or other caps. For example, FIG. 12 illustrates an alternative snap fit, in which cap 50 includes a groove 72 and raised portion 66 includes a ridge 70. Groove 72 snaps into ridge 70 to hold cap 50 in place. Cap 50 is preferably made of a material flexible enough to permit to be “snapped” into place over ridge 70 and subsequently removed. FIG. 13 illustrates an alternative threaded fit, in which cap 50 includes threading 76 and raised portion 66 includes matching threading 74. Cap 50 can thus screw onto end 36 for installation and be unscrewed to remove it. Cap 52 can also include these alternative structures for releasably holding it on end 42. In addition, each end 36 and 42 can have the same structure to install the respective cap, or they can have different structures.

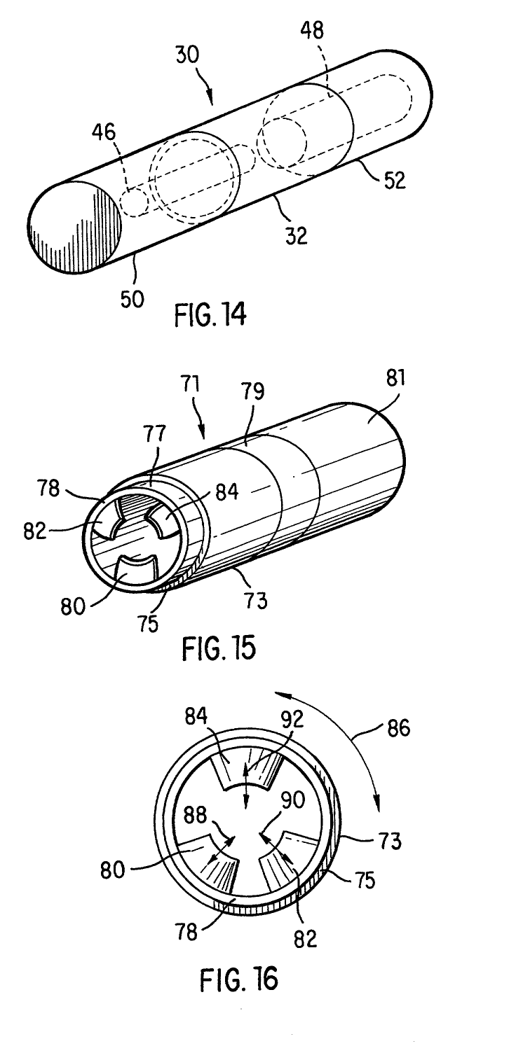

FIG. 14 is a perspective view of the cosmetic tool 30 shown with caps 50 and 52 installed, regardless as to the type of structure used to secure the caps. As shown, caps 50 and 52 can provide for an aesthetically pleasing cosmetic tool by covering the cosmetic products 46 and 48 when not in use.

### Cosmetic Tool with a Chuck Mechanism

FIG. 15 is a perspective view of an embodiment of a cosmetic tool 71 for releasably holding cosmetic products and including a chuck mechanism 73 for holding variable size cosmetic products. FIG. 16 is an end view of cosmetic tool 71. As shown in FIG. 15, cosmetic tool 71 includes chuck mechanism 73 on one end and can include another chuck mechanism 81 on the other end. A main body 79 joins and provides structural support for chuck mechanisms 73 and 81. Chuck mechanism 73 includes an end 78 having an edge 75 joined with a raised portion 77, similar to that shown for cosmetic tool 30 described above. End 78 includes jaws 80, 82, and 84 for releasably holding cosmetic products of variable dimensions such as cosmetic products having different cross-sectional diameters as illustrated above with respect to cosmetic products 22, 24, 46, and 48. Each chuck mechanism 73 and 81 can also have a cap such as those caps described above.

FIG. 16 illustrates operation of chuck mechanism 73. Rotational movement of chuck mechanism 73, as represented by arrows 86, causes lateral movement of jaws 80, 82, and 84, as represented by arrows 88, 90, and 92. A cosmetic product, when installed, is held securely in place by jaws 80, 82, and 84. The cosmetic product can be released by rotational movement of chuck mechanism 73 causing jaws 80, 82, and 84 to open. In addition to lateral movement, the jaws may also move in longitudinal direction as known in the art for conventional chuck mechanisms. Chuck mechanism 81 can operate in a similar fashion. Chuck mechanisms are known in the art and examples are described in the following patents, which are incorporated herein by reference: U.S. Pat. Nos. 6,129,363 and; 6,105,974. The term “chuck mechanism” includes any mechanism having movable jaws for releasably holding variable size items.

### Cosmetic Tool with a Compressible Material

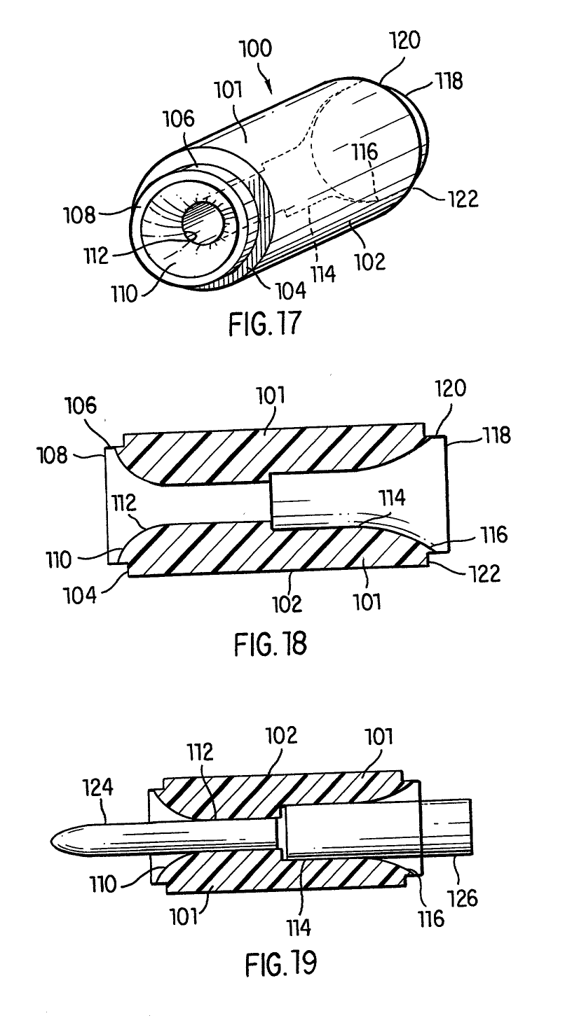

FIG. 17 is a perspective view of an embodiment of a cosmetic tool 100 for releasably holding cosmetic products and including a compressible material 101 for holding variable size cosmetic products. FIG. 18 is a side sectional view of cosmetic tool 100, and FIG. 19 is a side sectional view of cosmetic tool 100 with cosmetic products 124 and 126 installed. As shown in FIGS. 17 and 18, cosmetic tool 100 includes an end 108 having an edge 104 and a raised portion 106, and an end 118 having an edge 122 and a raised portion 120, similar to the ends for cosmetic tool 30 described above. Ends 108 and 118 can also have caps such as described above. A main body 102 contains compressible material 101, which has an aperture 112 at end 108 and an aperture 114 at end 118. Aperture 112 includes a curved portion 110 and aperture 114 includes a curved portion 116. The curved portions can permit easier installation of cosmetic products.

As shown in FIG. 19, cosmetic product 124 can be installed in aperture 112 and cosmetic product 126 can be installed in aperture 114. Compressible material 101 preferably has a sufficient compressibility to permit installation of variable dimensioned cosmetic products while also having sufficient rigidity to securely hold the cosmetic products in place. It can be implemented with, for example, a foam rubber material.

As shown, compressible material 101 can include apertures 112 and 114 of different diameters to permit installation of cosmetic products within a different range of diameters or dimensions. For example, aperture 112 can permit installation of various lip liner products having variable dimensions, and aperture 114 can permit installation of various lipstick products having variable dimensions. Since lip liner products in general have small dimensions than lipstick products, aperture 112 is small than aperture 114. Alternatively, compressible material 101 can have one uniform diameter aperture.

### Configurations for the Cosmetic Tools

The cosmetic tools 10, 30, 71, and 100 described above, or others consistent with the present invention, can have a variety of configurations. The entire cosmetic tool is preferably long enough to comfortably grasp but not so long as to be cumbersome or difficult to fit within a conventional purse or other container. It can, however, be made any desired length. The cosmetic tools can include a variety of types of holders on the ends, such as those examples described above, including holders for variable size cosmetic products. Furthermore, each end can include the same type of holder or a different type. When in place, the cosmetic products are preferable held securely enough to permit application of them. Releasable holders provide the advantage of, for example, permitting use of the cosmetic tool with conventional cosmetic products and permitting those products to be replaced in the cosmetic tool. Alternatively, instead of being releasably held in the holders, one of the cosmetic products can be permanently attached to the main body.

The main body and the optional caps can have a variety of cross-sectional shapes, and it is shown as round for illustrative purposes only. Those shapes can include a combination of curved surfaces (for example, round or oval); a combination of planar surfaces (for example, square, rectangular, hexagonal, or octagonal); or a combination of planar and curved surfaces (for example, a square-type shape having two opposite flat surfaces and two opposite curved surfaces).

The curved surfaces for any of the shapes can include concave surfaces, convex surfaces, or a combination. Also, the main body and caps can each have the same or a different configuration. In particular, the main body and caps can have a uniform configuration or a configuration that includes a combination of the cross-sectional shapes identified above. For the caps, the interior surface can have a different cross-sectional shape than the exterior surface; for example, they may have a square exterior shape and a round interior shape.

The main body and caps can be made of a variety of materials such as, for example, plastic or metal. The surface of the material can be reflective to use the main body or caps as a mirror, and those reflective surfaces can include, for example, a shiny plastic or a polished metal.

The exterior surface of the main body and caps can have any color, combinations of colors, or patterns. It may include logos, monograms, text, or other markings. For example, the cosmetic tool may include advertising or be personalized to identify the owner of it.

The cosmetic tool can be configured to hold different size cosmetic products, such as those shown with cosmetic tools 10, 30, and 100. For example, it can hold a lip liner and a lipstick. Alternatively, it can be configured to hold the same size cosmetic products. For example, it can hold two lipsticks.

### Method of Use

The following describes an example of a potential method of use for any of the cosmetic tools described above for applying lipstick: remove the cap over the lip liner; if necessary, remove lip liner cap; apply lip liner using the cap as a mirror; replace cap(s) over the lip liner; remove cap over the lipstick; if necessary, remove lipstick cap; if necessary, raise the lipstick product by firmly grasping the main body of the cosmetic tool and twisting the lipstick product, or by firmly grasping the lipstick product and twisting the main body; apply the lipstick using the cap as a mirror; and replace cap(s) over the lipstick.

The following describes an example of another potential method of use for any of the cosmetic tools described above for applying eye liner and eye shadow: remove the cap over the eye liner; if necessary, remove eye liner cap; apply eye liner using the cap as a mirror; replace cap(s) over the eye liner; remove cap over the eye shadow; if necessary, remove eye shadow cap; apply the eye shadow using the cap as a mirror; and replace cap(s) over the eye shadow.

Still other methods can involve use of other types of cosmetic products such as those identified above. In addition, if the caps are not used, then the cosmetic tool caps need not be removed and replaced in the methods.

While the present invention has been described in connection with an exemplary embodiment, it will be understood that many modifications will be readily apparent to those skilled in the art, and this application is intended to cover any adaptations or variations thereof. For example, various shapes, configurations, and materials for the cosmetic tool may be used without departing from the scope of the invention. This invention should be limited only by the claims and equivalents thereof.

What is claimed is:

1. A cosmetic tool, comprising:
a main body having a first end and a second end;
the first end having a first holder for holding a first cosmetic product; and
the second end having a second holder for holding a second cosmetic product,
wherein at least one of the first holder or the second holder provides for releasably holding the first cosmetic product or the second cosmetic product.

2. The cosmetic tool of claim 1 wherein:
the first holder provides for a friction fit between the first end and the first cosmetic product; and
the second holder provides for a friction fit between the second end and the second cosmetic product.

3. The cosmetic tool of claim 1 wherein:
the first holder is configured to hold a lipstick product; and
the second holder is configured to hold a lip liner product.

4. The cosmetic tool of claim 1 wherein the first holder and the second holder are each configured to hold one or more of the following: a lipstick product; a lip liner product; an eye liner product; or an eye shadow product.

5. The cosmetic tool of claim 1, further including:
a removable first cap enclosing the first cosmetic product on the first end; and
a removable second cap enclosing the second cosmetic product on the second end.

6. The cosmetic tool of claim 5 wherein the first end and the second end each include one of the following for releasably holding the first cap and the second cap: a friction fit; a snap fit; or a threaded fit.

7. The cosmetic tool of claim 5 wherein at least one of the first cap or the second cap includes a reflective outer surface.

8. The cosmetic tool of claim 5 wherein the first cap and the second cap are each composed of one of the following materials: a metal; or a plastic.

9. The cosmetic tool of claim 5 wherein at least a portion of the first cap and at least a portion of the second cap each has one of the following cross-sectional shapes: a combination of planar surfaces; a combination of curved surfaces; or a combination of curved and planar surfaces.

10. The cosmetic tool of claim 1 wherein at least a portion of the main body has one of the following cross-sectional shapes: a combination of planar surfaces; a combination of curved surfaces; or a combination of curved and planar surfaces.

11. The cosmetic tool of claim 5 wherein the elongated body, the first cap, and the second cap have substantially the same cross-sectional shape.

12. The cosmetic tool of claim 5 wherein at least one of the first cap or the second cap has exterior and interior surfaces, the exterior surface having a different cross-sectional shape than the interior surface.

13. The cosmetic tool of claim 1 wherein at least one of the first or second holders includes an aperture for providing a friction fit with a cosmetic product.

14. The cosmetic tool of claim 1 wherein at least one of the first or second holders includes a threaded aperture for releasably holding a cosmetic product having matching threading.

15. The cosmetic tool of claim 1 wherein at least one of the first or second ends includes a chuck mechanism for releasably holding cosmetic products having variable size dimensions.

16. The cosmetic tool of claim 1 wherein at least one of the first or second ends includes a compressible material, having an aperture, for releasably holding cosmetic products having variable size dimensions.

17. A cosmetic tool, comprising:
a main body having a first end, a second end, and a central axis;
the first end having a first holder for releasably holding a first cosmetic product substantially parallel to the central axis and extending from the first end; and
the second end having a second holder for releasably holding a second cosmetic product substantially parallel to the central axis and extending from the second end.

18. The cosmetic tool of claim 17, further including:
a first cap removably held on the first end; and
a second cap removably held on the second end.

19. The cosmetic tool of claim 17 wherein at least one of the first or second ends is configured to releasably hold cosmetic products having variable dimensions.

20. The cosmetic tool of claim 17 wherein the first and second holders are configured to hold cosmetic products of different dimensions.

21. The cosmetic tool of claim 17 wherein at least one of the first or second holders includes an aperture for providing a friction fit with a cosmetic product.

22. The cosmetic tool of claim 17 wherein at least one of the first or second holders includes a threaded aperture for releasably holding a cosmetic product having matching threading.

23. A method of applying cosmetic products, comprising:
applying a first cosmetic product releasably held on a first end of a cosmetic tool; and
applying a second cosmetic product releasably held on a second end of the cosmetic tool.

24. The method of claim 23 wherein:
the applying the first cosmetic product step includes:
removing a first cap enclosing the first cosmetic product on the cosmetic tool; and
using a surface of the first cap as a mirror during the application of the first cosmetic product; and
the applying the second cosmetic product step includes:
removing a second cap enclosing the second cosmetic product on the cosmetic tool; and
using a surface of the second cap as a mirror during the application of the second cosmetic product.

25. The method of claim 23 wherein:
the applying the first cosmetic product step includes applying a lip liner product; and
the applying the second cosmetic product step includes applying a lipstick product.

26. The method of claim 23 wherein:
the applying the first cosmetic product step includes applying an eye liner product; and
the applying the second cosmetic product step includes applying an eye shadow product.
